(19) United States
(12) Patent Application Publication
(10) Pub. No.: US 2002/0114931 A1
(43) Pub. Date: Aug. 22, 2002

(54) Polymer circuit

(76) Inventors: Luciano Beghello, Huddinge (SE); Martti Toivakka, Oberanven (LU)

Correspondence Address: BANNER & WITCOFF, 1001 G STREET N W, SUITE 1100, WASHINGTON, DC, 20001, US

(21) Appl. No.: 09/861,852

(22) Filed: May 22, 2001

(30) Foreign Application Priority Data
Feb. 19, 2001 (SE) 0100553-7

(51) Int. Cl. B42D 15/00

(52) U.S. Cl. 428/209

(57) ABSTRACT

Security element for antifalsification purposes comprising a substrate (11), contact points (A through H) and at least one conductive polymer (12, 13 and 14) connecting at least two contact points.

The present invention concerns the field of antifalsification devices, i.e. technical devices, elements and functionalities which, when added to an object, prevent the falsification thereof.

### BACKGROUND OF THE INVENTION

The availability of advanced photocopying machines, computer software for graphic design, and advanced printing equipment has made it easier to replicate valuable documents, such as bank notes, traveller's cheques, bank cheques, passports, tickets, lottery tickets, seals, identity documents and driving licenses, to mention a few examples. Consequently there is a demand for methods for protecting documents against forgery, including security features to be incorporated on or even into the substrate used for said valuable documents.

When considering security features, it should be noted that there is a demand for primary features, that is security features, which are easily identified without the aid of special equipment, as well as secondary security features, or features identified only through a closer study of the document. Primary security features include water marks, tactile details, micro text, holograms and similar features, readily discernible by an average user. Secondary features include fluorescence, e.g. UV-fluorescence, conductivity, reflectance, magnetic properties etc, possible to determine only using suitable apparatus. The detection of secondary security features can be done by automatic measurements, which can be performed without human contribution, thereby possible to be incorporated in vending machines, exchange automates, automatic telling machines etc.

Presently used solutions include magnetic elements, electrically conductive metal elements, the use of specific chemicals, such as rare earth metals, fluorescent ink, UW-fluorescent fibres, holograms, cinegrams etc. Magnetic elements are however susceptibel of de-magnetisation and metall based elements are unreliable for conductivity measurements, as they may break or corrode. Optical elements require more advanced apparatuses for analysis, and the function of both the element and the apparatuses is easily impaired by dirt or wear.

One objective of the present invention is to integrate several security features, primary and/or secondary, in a durable, flexible and comparatively simple and inexpensive element or device. Another objective is to make available a novel security feature which can be easily identified by automated measurements, such as the measurement of conductivity. Further objectives include incorporation of interactive features in a security element, allowing the user to verify the authenticity of the document without the aid of any auxilliary apparatus.

### SUMMARY OF THE INVENTION

The above problems are solved by a conductive polymer based circuit comprising a substrate, contact points and at least one conductive polymer connecting at least two contact points. The invention is defined in the description and attached claims, incorporated herein by reference.

### SHORT DESCRIPTION OF THE DRAWINGS

The invention will be disclosed in further detail in the description, non-limiting examples and claims, and illustrated in the attached drawings, in which

FIG. 1 shows a schematic view of a device consisting of two adjoined sheets of conductive polymer foil, 1 and 2, having four contact points 3, 4, 5, and 6;

FIG. 2 shows a thread shaped device consisting of two adjoined sheets of conductive polymer foil, 1 and 2, having four contact points 7, 8, 9, and 10; and

FIG. 3 shows a schematic view of a planar polymer circuit 11, comprising eight contact points A, B, C, D, E, F, G, and H, connected by conductive polymer strands 12, 13, and 14. Additionally, a functional element 15 is connected to the strand 14.

### DESCRIPTION

The term “security document” is meant to encompass all valuable documents, such as bank notes, traveller's cheques, bank cheques, passports, tickets, lottery tickets, seals, identity documents and driving licenses etc.

The term “security element” is meant to comprise devices or elements both for affixing to security documents or elements, which in themselves can be used to seal or label a product and to function as a verification of the authenticity of said product. Examples of such products include tobacco and alcohol products, perfumes, exclusive foods, computer software products, medical products, pharmaceuticals, recorded music on optional carriers etc.

Paper is a material traditionally associated with high resistivity or low conductivity. As an example it can be mentioned that paper has been used as insulation in electric applications, for example in cables. The resistivity of paper is in the interval of about 10¹¹−10¹⁴ Ohm cm and the corresponding conductivity in the interval of about 10⁻¹¹−10⁻¹⁴ S/cm.

Polymers have traditionally been considered to have low electrical conductivity. Attempts to increase the conductivity of polymers has comprised the addition of conductive fillers, such as carbon blacks, metal particles and flakes, metal fibres, carbon fibres and the like. A new class of organic polymers capable of conducting electricity has however recently been developed. These polymers become conductive upon partial oxidation or reduction, a process commonly referred to as doping.

Suitable polymers for use according to the present invention are conductive polymers exhibiting a conductivity in the range of about 10⁻¹⁰ to 10² S/cm, either alone or blended with commercially available so called commodity polymers. One example is the group of polyaniline polymers, e.g. Panipol® (Panipol Ltd., Porvoo, Finland), and these polymers can be used as such, or blended with polyester, polyethylene, polypropylene, polystyrene, PVC, phenol formaldehyde resins, and different types of thermoplastic elastomers. Preferably transparent or at least translucent polymer blends are used.

Another example is the polymer known as PEDOT (Poly[ethylenedioxythiophene]) which can reach an electrical conductivity of about 10⁴ S/m. Depending on the desired properties, such as strength, PEDOT may have to be blended with other polymers, for example added to a matrix of polymers such as polyester, polyethylene, polypropylene, polystyrene, PVC, phenol formaldehyde resins, and different types of thermoplastic elastomers. Preferably transparent or at least translucent polymer blends are used.

Another example is the conductive polymers based on 3,4-ethylenedioxythiophene, a compound also known as the EDT monomer (sold as Baytron M™ or EDT, Bayer Corporation Electronic Chemicals, Pittsburgh, USA). The conductive polymer poly-3,4-ethylenedioxythiophene-polystyrenesulfonate (Baytron p™ or PEDT/PSS, Bayer Corporation Electronic Chemicals, Pittsburgh, USA) is also available as an aqueous dispersion.

When the polymer is available in liquid form, e.g. as an aqueous dispersion as above, the sequrity feature is printed on the surface of the substrate.

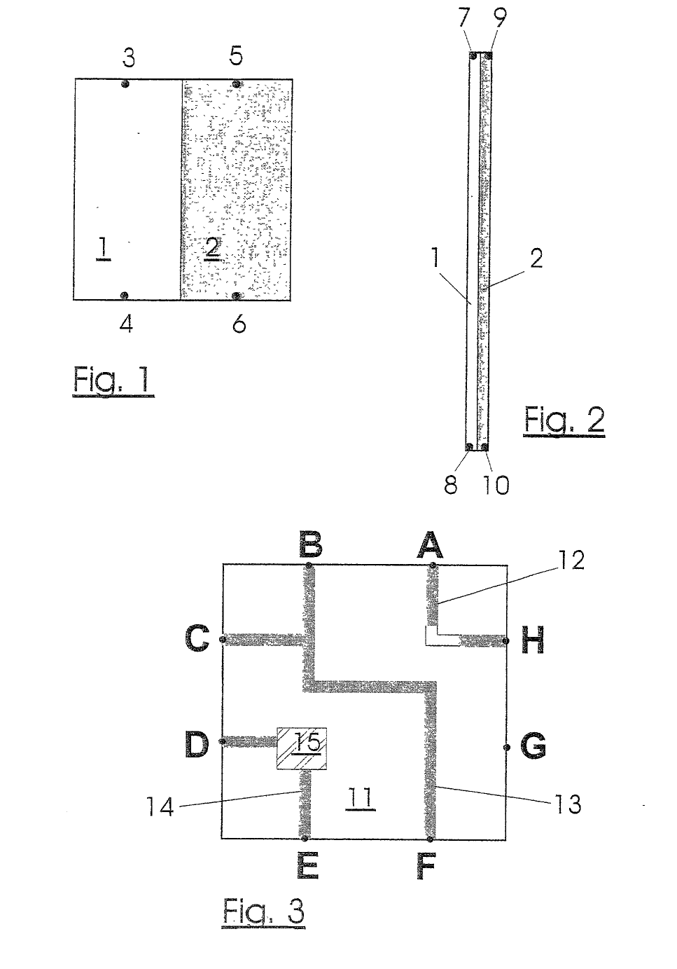

The present invention makes available a novel planar polymer circuit which, according to a basic embodiment is a device consisting of two adjoined sheets of conductive polymer foil, 1 and 2, having four contact points 3, 4, 5, and 6. See FIG. 1. Using two conductive polymers or blends of conductive polymers and other polymers, and/or fillers, the device exhibits different conductivity when the conductivity is measured between the contact points 3 and 4, and 5 and 6. Further, the directional anisotropy of conductivity, which can be achieved in conductive polymers, enables the differentiation between the direction of the measurements. Thus the measurements 4 to 3, and 6 to 5 would give different readings. For verification purposes, it is an advantage that so much information can be coded in a binary system, as the present planar device of this embodiment. Additional measurements between contact points 3 and 6, and 5 and 4, as well as 3 and 5, and 4 and 6, can give additional information, useful to establish the identity of the security element.

The above contact points can be metallized areas in electrically conductive contact with the polymer, or an area of the polymer being exposed and rendered suitable for contacting a parts of a measuring apparatus used to make a conductivity reading and/or to lead an electric current though the conductive polymers.

One embodiment of the binary device described in association with FIG. 1 above, is a thread like device as shown in FIG. 2. This planar polymer circuit or binary device consists of two adjoined sheets of conductive polymer foil, 1 and 2, having four contact points 7, 8, 9, and 10. Each sheet 1, and 2, exhibits a different conductivity, and the sheets can be separated by a thin insulating layer. Measurements between the contact points will give different conductivity values and thus provide unique and distinct information.

According to a third embodiment, illustrated schematically in FIG. 3, strands of conductive polymers 12, 13, and 14, are provided on a substrate 11. The substrate can be a polymer substrate or a fibrous substrate, including a polymer foil, self-adhesive foils, fibre based sheets etc.

The polymer strands emanate from contact points A, B, C, D, E, F, G, and H, located at the periphery of the substrate 11. Contact points can also be located elsewhere on the substrate, for example in the middle of a strand (Not shown). The strands can be formed of conductive polymers with different conductivity, both in absolute terms and with respect to directional anisotropy of conductivity. The strands can also contain discontinuities, as indicated schematically for strand 12, emanating from contact points A and H, but being interrupted in the middle. The discontinuity can be in the form of a physical discontinuity, meaning that the conductive material stops, leaving a gap between the ends of the strands. The discontinuity can also be a chemical discontinuity, meaning that the chemical properties of the strand change, making this feature practically impossible to detect for a counterfeiter who has no access to the original design of the security device.

The strand can also form circuits in the sense that they connect more than two connecting points, as shown for strand 13, connecting B, C, and F.

The inventive security device preferably comprises functional elements, interacting with the conductive polymers, such as the functional element 15 connected to the strand 14 in FIG. 3. Examples of functional elements include materials emitting a signal in response to being stimulated by a weak current, for example materials changing colour, reflectivity or other optical properties, or emitting light, IR-radiation, UV-radiation, or materials oscillating in response to an electrical stimulus.

According to the invention, the functionality of the polymer circuit can be either binary, that is having an “on/off” character. A section of the polymer, for example a section between two contact points, is either conductive or not. The functionality can also be triple or fourfold, meaning that a specific section either is conductive or not, and if it is conductive, the conductivity is either above or below a given value. Depending on the accuracy in analysing the security element, a fifth and further level can be added.

According to one embodiment of the invention, at least one of the contact points in a singular, binary or multiple polymer device consists of a thermocouple which, when subject to the body warmth of a user holding the thermocouple/contact point between the tips of his/her fingers, emits an electric current, which in turn trigger a response from the polymer circuit.

The inventive security features according to the invention can be manufactured in the form of foils, threads, bands or patches, to be attached to the surface of security documents, or integrated in the same, such as a thread running altematingly in the paper and being exposed on the surface of a bank note. The inventive security element can also be manufactured as an integrated part of the security document, for example by making the entire document function as the substrate for a circuit.

The devices and/or elements according to the present invention are light weight, durable substantially planar and suitable for mass production to a low cost, nevertheless having the capacity of including multiple parameters. Said parameters can be both so called primary security features, identified by an unskilled person without technical aids, and so called secondary parameters, easily identified using simple and automated apparatuses. Further advantages will be apparent when applying the inventive concept to various antifalsification applications.

Although the invention has been described with regard to its preferred embodiments, which constitute the best mode presently known to the inventors, it should be understood that various changes and modifications as would be obvious to one having the ordinary skill in this art may be made without departing from the scope of the invention as set forth in the claims appended hereto.

1. Security element for antifalsification purposes, characterized in that said element comprises a substrate (11), at least two contact points (3, 4, 5, 6, 7, 8, 9, 10 ) and at least one conductive polymer (1, 2) connecting said at least two contact points.

2. Security element according to claim 1, characterized in that the substrate (11) is paper sheet.

3. Security element according to claim 1, characterized in that the conductive polymer is printed on said substrate.

4. Security element according to claim 1, characterized in that the substrate (11) is a non-conductive polymer sheet.

5. Security element according to claim 1, characterized in that the at least one conductive polymer is chosen from the group comprising polyaniline polymers, polyanliline polymers blended with polyester, polyethylene, polypropylene, polystyrene, PVC, phenol formaldehyde resins, and thermoplastic elastomers.

6. Security element according to claim 1, characterized in that at least two conductive polymers are used to connect at least two pairs of contact points.

7. Security element according to claim 6, characterized in that among the at least two conductive polymers used to connect at least two pairs of contact points, one polymer is discontinuous.

8. Security element according to claim 6, characterized in that among the at least two conductive polymers used to connect at least two pairs of contact points, one polymer incorporates a functional element.

9. Security element according to claim 8, characterized in that the functional element is an element emitting a signal in response to an electric current passing through the conductive polymer.

10. Security element according to claim 8, characterized in that at least one contact point consists of a thermocouple capable of generating an electric current when subjected to heat and the functional element is an element emitting a signal in response to an electric current passing through the conductive polymer.
